(19) United States
(12) Patent Application Publication
(10) Pub. No.: US 2011/0214428 A1
(43) Pub. Date: Sep. 8, 2011

(54) HYBRID VENTURI COOLING SYSTEM

(75) Inventors: Borys SHERSHNYOV, Moscow (RU); Leonid GINESSIN, Moscow (RU); Almaz VALEEV KAMILEVICH, Kazan (RU)

(73) Assignee: GENERAL ELECTRIC COMPANY, Schenectady, NY (US)

(21) Appl. No.: 12/917,784

(22) Filed: Nov. 2, 2010

(30) Foreign Application Priority Data
Mar. 2, 2010 (RU) 2010107420

(51) Int. Cl. F02C 3/00

(52) U.S. Cl. 60/754

(57) ABSTRACT

A venturi device for a turbine combustor includes a substantially annular outer liner; a substantially annular inner liner; a venturi channel located between the substantially annular outer and inner liners; the substantially annular outer and inner liners being substantially V-shaped in axial cross-section, thereby defining a throat region; the substantially annular outer liner formed with an array of impingement holes and the substantially annular inner liner formed with a plurality of vortex generators facing the substantially annular outer liner.

### RELATED APPLICATION

This application claims priority from Russian Application Serial No. 2010-107420, filed Mar. 2, 2010, which is hereby incorporated by reference in its entirety.

### BACKGROUND OF THE INVENTION

This invention relates to gas turbine combustor technology and, more specifically, to a novel combustor venturi with improved cooling.

It is known to achieve a significant reduction in NOₓ emissions from a combustion turbine without aggravating ignition, unburnt hydrocarbon or carbon monoxide emission problems, by utilizing first and second combustion chambers or stages interconnected by a throat region. See for example, commonly-owned U.S. Pat. No. 4,292,801.

In the more recent commonly-owned U.S. Pat. No. 5,127,221, there is disclosed a method and apparatus for creating a plenum about the throat region and cooling the throat wall sections utilizing compressor air flowing in an annular passage between the combustor liner and a surrounding casing or flow sleeve.

In U.S. Pat. No. 6,427,446, there is disclosed a technique for cooling the throat wall by impingement cooling, again using cooling air flowing in a passage between the combustor liner and a surrounding flow sleeve.

There remains a need for a venturi cooling system that achieves even greater cooling effectiveness.

### BRIEF DESCRIPTION OF THE INVENTION

In a first exemplary but nonlimiting embodiment, there is provided a venturi device for a turbine combustor comprising a substantially annular outer liner; a substantially annular inner liner; a venturi channel located between the substantially annular outer and inner liners; the substantially annular outer and inner liners being substantially V-shaped in axial cross-section, thereby defining a throat region; the substantially annular outer liner formed with an array of impingement cooling holes and said substantially annular inner liner formed with a plurality of vortex generators facing the substantially annular outer liner and the array of impingement cooling holes.

In another exemplary but nonlimiting embodiment, there is provided venturi device for a turbine combustor comprising a substantially annular outer liner; a substantially annular inner liner; a venturi channel located between the substantially annular outer and inner liners; the substantially annular outer and inner liners being substantially V-shaped in axial cross-section, thereby defining a throat region; the substantially annular outer liner formed with an array of impingement cooling holes; and said substantially annular inner liner formed with a plurality of vortex generators facing the array of impingement cooling holes, and a plurality of upstanding fins in the throat region, extending radially outwardly into the venturi channel toward said substantially annular outer liner.

In still another exemplary but nonlimiting embodiment, there is provided a turbine combustor comprised of a radially inner liner and a radially outer flow sleeve, the radially inner liner parallel with a venturi comprising a venturi device for a turbine combustor comprising a substantially annular outer liner; a substantially annular inner liner; a venturi channel located between said substantially annular outer and inner lines; said substantially annular outer and inner liners being substantially V-shaped in axial cross-section, thereby defining a throat region; said substantially annular outer liner formed with an array of impingement cooling holes; wherein said substantially annular inner and outer V-shaped liners form a plenum chamber closed by another annular member, said outer annular member having one or more apertures therein adapted to supply cooling air to said plenum chamber, and further wherein said venturi channel is open at opposite ends of said venturi channel such that cooling air entering the venturi channel through the one or more apertures flows in opposite directions at said throat region.

### BRIEF DESCRIPTION OF THE DRAWINGS

FIG. 1 is a side elevation view in cross section showing a prior art combustor incorporating a venturi cooled by impingement cooling;

FIG. 2 is a partial cross-section of a combustor venturi in accordance with a exemplary but non-limiting embodiment of the invention;

FIG. 3 is a perspective view of the venturi cross section shown in FIG. 2; and

FIG. 4 is another perspective view of the venturi cross section shown in FIG. 2.

### DETAILED DESCRIPTION OF THE INVENTION

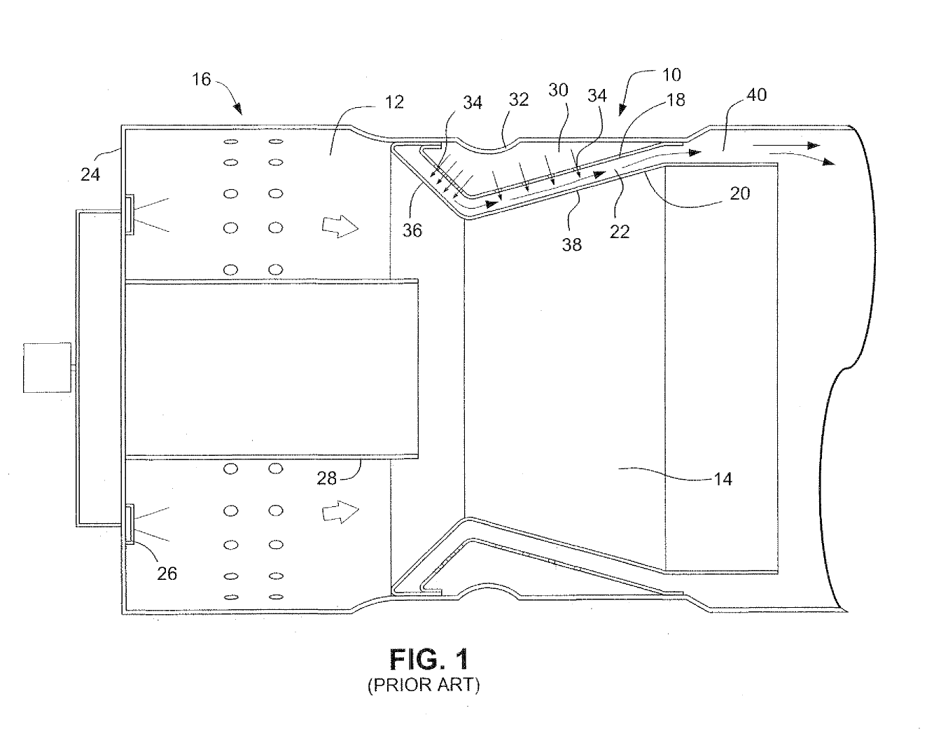

Referring to FIG. 1, a prior venturi (or throat region) cooling system is illustrated. The venturi 10 is located axially between first and second combustion chamber regions 12, 14 defined by a combustor liner 16. The venturi is comprised of a radially outer wall 18 and a radially inner wall 20, with a cooling flow passage or channel 22 therebetween. The combustor liner 16 extends downstream and beyond the venturi 10 where typically it is joined to a transition piece or duct (not shown) that supplies the hot combustion gases to the turbine first stage. The combustor liner 16 extends upstream to a combustor end cover 24 that supports the nozzles 26, 28 projecting into the combustion chamber. An annular plenum 30 is formed by the liner 16 and the venturi 10, such that the plenum surrounds the venturi and, via one or more apertures 32 spaced about the liner 16, supplies cooling air to the venturi plenum 30. More specifically, cooling air supplied to the plenum 30 flows into the passage or channel 22 through an array of impingement cooling holes 34 in both the converging portion 36 and diverging portion 38 of the outer venturi wall 18. Channel 20 is closed at its upstream end and opens at its downstream end 40. The cooling air exits the venturi channel via the downstream open end 40 where it joins the combustion gases flowing away from the combustion chamber toward the first stage of the turbine.

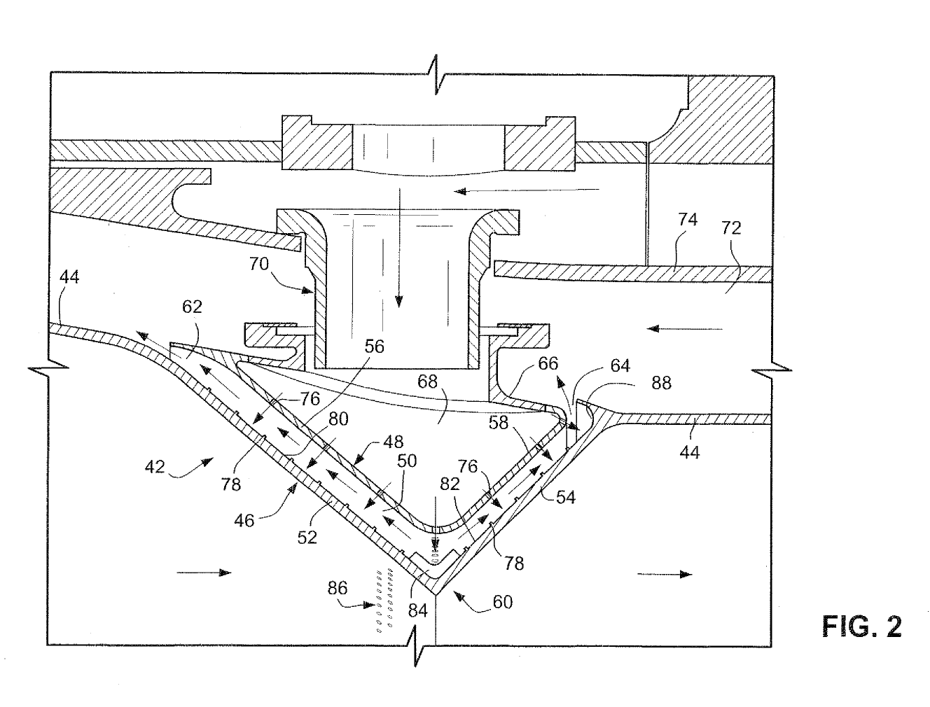

Turning now to FIGS. 2-4, a venturi 42 is illustrated in accordance with an exemplary but nonlimiting embodiment of the invention. The venturi 42 is formed in part by the combustor liner 44, and includes an inner liner wall 46 and an outer liner wall 48, with a venturi flow passage or channel 50 therebetween. The inner liner wall 46 is formed with a converging portion 52 and a diverging portion 54 (relative to a left-to-right combustion gas flow direction) and, similarly, the outer liner wall 48 is formed with corresponding converging and diverging portions 56, 58 respectively, thus defining a narrowed venturi throat region 60. Note that the flow passage or channel 50 is open at both the upstream end 62 and the downstream end 64.

An annular combustor wall portion 66 surrounds the venturi 42, forming an annular plenum chamber 68. In the exemplary embodiment, cooling air is supplied to the plenum chamber 68 via a plurality of cooling bushings or thimbles 70. Unlike the above-described prior arrangement, however, the cooling air is supplied directly from the CDC extraction air rather than from the flow in the annular passage 72 between the combustor liner 44 and surrounding flow sleeve 74. The CDC extraction air is not only cooler than the flow in the annular passage 72 between the combustor liner and the flow sleeve, but it is also at a higher pressure resulting in more effective impingement cooling of the inner venturi wall 80, 82.

More specifically, the cooling air in the plenum chamber 68 is supplied to the passage or channel 50 via an annular array of circumferentially spaced impingement cooling holes 76 provided in both the converging and diverging portions 56, 58 of the outer liner wall 48.

The inner liner wall 46 is formed with an annular array of axially-spaced annular vortex generator ribs (or turbulators) 78 on both the converging and diverging (or fore and aft) surfaces 80, 82 of the inner liner wall. The ribs 78 are staggered axially relative to the annular rows of impingement holes 76. In other words, the ribs 78 are located between adjacent rows of impingement holes 76 and the respective pitches of the holes and ribs are maintained about the venturi. This arrangement produces a complex interaction between air jets, secondary flows, the annular turbulators and spent cooling air, providing benefits such as intense mixing of cooling air in the annular passage or channel 50; significantly reduced impact of cross-flows on air jets; and effective destruction of the boundary layer along the surfaces 80, 82. Different rib cross-sectional shapes may be employed so long as heat transfer is increased and so long as the pitch alignment with the rows of impingement cooling holes 76 is maintained.

At the venturi throat or throat region 60, the inner liner wall 46 is formed (or provided) with axially extending fins 84, spaced annularly about the throat 60, and extending along both the converging and diverging portions 52, 54 of the inner liner wall 46. These fins, in side elevation, may have a V or chevron shape and greatly enhance cooling at the throat.

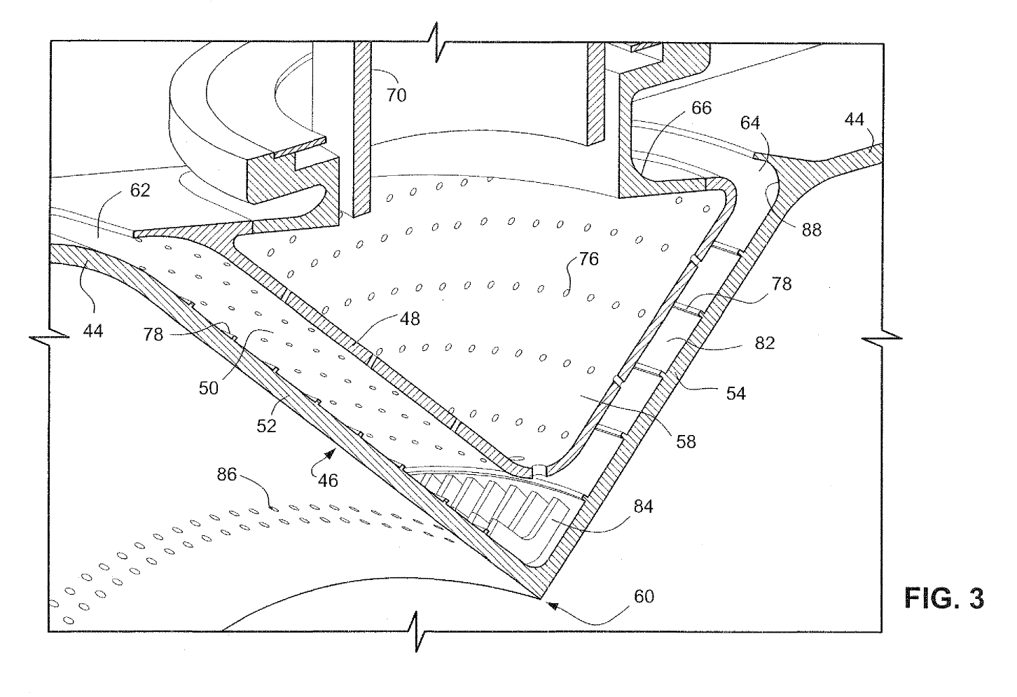

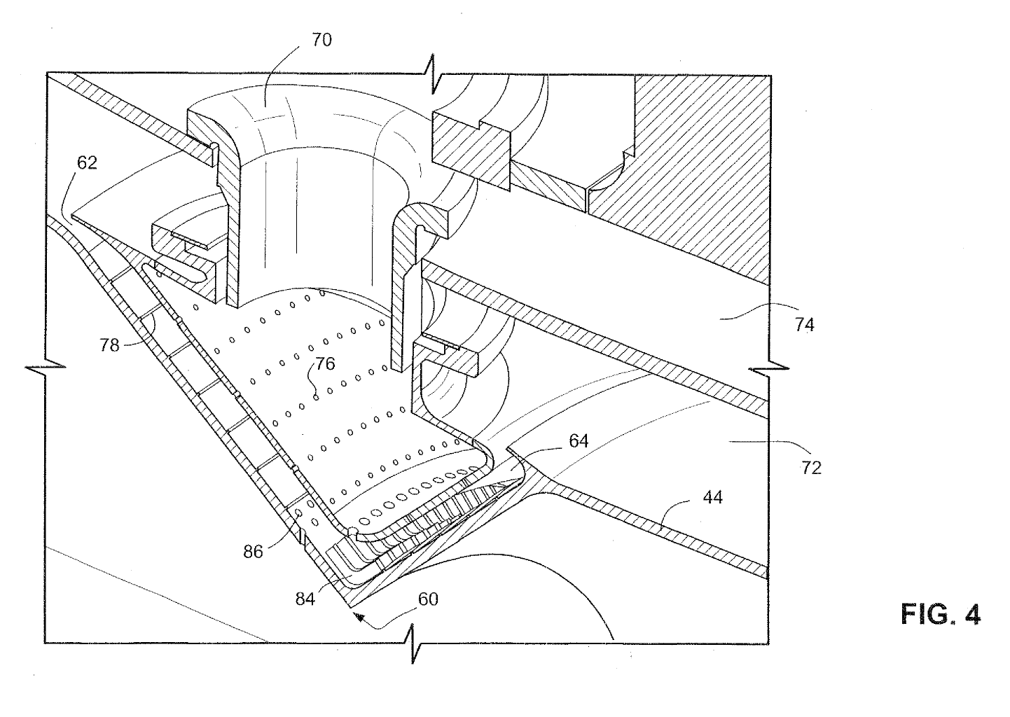

In addition, an array of film cooling holes 86 (best seen in FIGS. 3 and 4) may be provided in the radially inner liner, upstream of the fins 84, and, for example, between adjacent turbulators or ribs 78, and adjacent the throat region 60. The film cooling holes provide local film cooling flow along the inner surface of the converging portion 52 of the inner liner wall 46 proximate and upstream of the throat 60.

In use, the air supplied to the flow passage 50 flows in opposite directions, exiting the passage 50 at both the upstream and downstream ends 62, 64, respectively. Note in this regard that the wall profile at downstream end 64 is turned at the “bull nose” configuration (or bull nose curve) 88 to re-direct the exiting cooling air in an upstream direction, i.e., the same direction as air exiting the upstream end 62. Note that some of the impingement cooling holes 76 are directed generally at the bull nose curve to ensure adequate cooling at the turn.

In addition, the dual-direction flow at the throat substantially eliminates cross-flow at the throat edge internal surface which is essential for local cooling efficiency.

This venturi configuration arrangement permits fine tuning of the cooling effectiveness of the venturi to enable the possibility of having variable cooling effectiveness in different areas of the system; optimal cooling of the venturi throat; and reduced impact of cross-flow on the air jets in the venturi throat region.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A venturi device for a turbine combustor comprising:
a substantially annular outer liner;
a substantially annular inner liner;
a venturi channel located between said substantially annular outer and inner liners;
said substantially annular outer and inner liners being substantially V-shaped in axial cross-section, thereby defining a throat region;
said substantially annular outer liner formed with an array of impingement cooling holes and said substantially annular inner liner formed with a plurality of vortex generators facing said substantially annular outer liner and said array of impingement cooling holes.

2. The venturi device of claim 1 wherein said substantially annular inner liner is provided with a plurality of upstanding fins in said throat region, extending radially outwardly toward said substantially annular outer liner.

3. The venturi device of claim 2 wherein said substantially annular inner liner is formed with a plurality of film-cooling holes axially adjacent said throat region.

4. The device of claim 1 wherein said venturi channel is open at opposite ends of said venturi channel.

5. The device of claim 1 wherein said substantially annular inner and outer V-shaped liners form a plenum chamber closed by another annular member, said another annular member having one or more apertures therein adapted to supply cooling air to said plenum chamber.

6. The device of claim 5 wherein said venturi channel is open at opposite ends thereof.

7. The device of claim 3 including a plurality of film cooling holes in said radially inner liner, upstream of said throat.

8. A venturi device for a turbine combustor comprising:
a substantially annular outer liner;
a substantially annular inner liner;
a venturi channel located between said substantially annular outer and inner lines;
said substantially annular outer and inner liners being substantially V-shaped in axial cross-section, thereby defining a throat region;
said substantially annular outer liner formed with an array of impingement cooling holes; and
said substantially annular inner liner formed with a plurality of vortex generators facing said array of impingement cooling holes, and a plurality of upstanding fins in said throat region, extending radially outwardly into said venturi channel toward said substantially annular outer liner.

9. The venturi device of claim 8 wherein said venturi channel is open at opposite ends of said venturi channel.

10. The venturi device of claim 8 wherein said substantially annular inner and outer V-shaped liners form a plenum chamber closed by another annular member, said another annular member having one or more apertures therein adapted to supply cooling air to said plenum chamber.

11. The venturi device of claim 10 wherein said one or more apertures are defined by one or more respective hollow bushings adapted to feed compressor extraction air directly to said plenum.

12. A turbine combustor comprised of a radially inner liner and a radially outer flow sleeve, the radially inner liner parallel with a venturi comprising:
a venturi device for a turbine combustor comprising:
a substantially annular outer liner;
a substantially annular inner liner;
a venturi channel located between said substantially annular outer and inner lines;
said substantially annular outer and inner liners being substantially V-shaped in axial cross-section, thereby defining a throat region;
said substantially annular outer liner formed with an array of impingement cooling holes; wherein
said substantially annular inner and outer V-shaped liners form a plenum chamber closed by another annular member, said outer annular member having one or more apertures therein adapted to supply cooling air to said plenum chamber, and further wherein said venturi channel is open at opposite ends of the venturi channel such that cooling air entering said venturi channel through said one or more apertures flows in opposite directions at said throat region.

13. The turbine combustion of claim 12 where said substantially annular inner liner is formed with a plurality of vortex generators facing said substantially annular outer liner and a plurality of film-cooling holes axially adjacent said throat region.

14. The turbine combustor of claim 12 wherein said substantially annular inner liner is provided with a plurality of upstanding fins in said throat region, extending radially outwardly toward said substantially annular outer liner.

15. The turbine combustor of claim 12 wherein said one or more apertures are defined by one or more respective hollow bushings, said hollow bushings extending through said flow sleeve such that air entering said plenum chamber is supplied from a region outside said flow sleeve.

16. The turbine combustor of claim 12 wherein said array of impingement cooling holes and said vortex generators are axially offset from each other.

17. The turbine combustor of claim 12 wherein cooling air exiting said opposite ends of said venturi channel is directed in a single upstream direction.

18. The turbine combustor of claim 13 wherein said substantially annular inner liner is provided with a plurality of upstanding fins in said throat region, extending radially outwardly toward said substantially annular outer liner.

19. The turbine combustor of claim 12 wherein said inner liner is provided with film cooling holes axially upstream of said throat region.

20. The turbine combustion of claim 14 wherein said inner liner is provided with film cooling holes axially upstream of said throat region.
